(19) United States
(12) Patent Application Publication
(10) Pub. No.: US 2026/0351094 A1
(43) Pub. Date: Nov. 5, 2026

(54) SELF-CHECKOUT UTILIZATION OPTIMIZATION

(71) Applicant: NCR Voyix Corporation, Atlanta, GA (US)

(72) Inventors: Itamar David Laserson, Givat Shmuel (IL); Shiran Abadi, Tel-Aviv (IL); Shay Marom, Kiryat Tiv'on (IL); Ayelet Sarel, Kiryat Tiv'on (IL)

(21) Appl. No.: 19/195,251

(22) Filed: Apr. 30, 2025

(51) Int. Cl. G07G 1/00

(52) U.S. Cl. CPC G07G 1/0009

(57) ABSTRACT

Methods and systems for optimizing self-checkout utilization analyzes occupancy states and root causes through a machine learning model (MLM) trained on millions of hourly operational data samples. The MLM evaluates relationships between occupancy states and various operational parameters including open lane ratios, attendant staffing, malfunction frequency, cash management efficiency, and intervention rates. By processing historical operational data, the methods and system identify primary factors affecting utilization and provide specific interpretations for occupancy issues at both hourly and store-wide levels, enabling targeted improvements in self-checkout efficiency.

### BACKGROUND

Self-checkout (SCO) deployments represent significant investments for retailers worldwide, yet many struggle to fully utilize these systems. Data observations reveal widespread issues where stores either underutilize their SCO capacity or experience traffic exceeding capacity. Multiple challenges contribute to suboptimal utilization, including insufficient units during peak traffic, suboptimal attendant scheduling, frequent malfunctions, inefficient cash management leading to degraded performance, non-compliance with lane opening policies, and excessive interventions reducing throughput.

### BRIEF DESCRIPTION OF THE DRAWINGS

FIG. 1 is a diagram of a system for self-checkout (SCO) utilization optimization, according to an example embodiment.

FIG. 2 is a flow diagram of a method for SCO utilization optimization, according to an example embodiment.

FIG. 3 is a flow diagram of another method for SCO utilization optimization, according to an example embodiment.

### DETAILED DESCRIPTION

Retailers worldwide are increasingly deploying self-checkout (SCO) systems as critical components of their operations. While these systems represent substantial financial commitments through subscription-based models, the actual return on investment often falls short of expectations. Data analysis from retail environments demonstrates persistent challenges in achieving optimal utilization of self-checkout resources.

The complexity of SCO operations introduces multiple potential impediments to efficient utilization. These include misalignment between available units and peak traffic demands, inadequate staffing patterns that extend intervention response times, equipment reliability issues leading to downtime, suboptimal cash handling procedures resulting in degraded performance, inconsistent adherence to operational policies, and excessive transaction interruptions that reduce overall throughput capacity.

The fundamental technical challenge lies in accurately identifying and quantifying the root causes of SCO utilization inefficiencies across millions of transaction hours. Traditional analysis methods cannot effectively process the massive volume of operational data points needed to establish meaningful correlations between occupancy states and their underlying technical and operational determinants.

The technology presented herein enhances SCO technology through a specialized machine learning system that processes extensive operational datasets. By implementing a Random Forest machine learning model (MLM) trained on millions of hourly samples, the technology establishes precise relationships between occupancy states and multiple operational parameters, enabling data-driven optimization of SCO systems through automated root cause analysis.

In an embodiment presented herein, a Random Forest Classifier MLM processes operational data including tender time, clear time, itemization time, intervention time, and transaction volumes relative to historical patterns. The MLM evaluates these parameters against occupancy states to determine their relative impact on utilization efficiency.

In various embodiments, the methods and system generate specific interpretations of occupancy issues to provide actionable insights about parameter adjustments needed to achieve optimal capacity status. For example, when tender times exceed optimal thresholds, the methods and system calculate potential values that would restore adequate capacity status.

In an embodiment presented herein, the methods and system output interpretations to store managers through a dashboard interface that plots relationships between potential root cause values and occupancy states, enabling clear visualization of issues affecting terminal utilization. The interpretations provide specific guidance for each hour where occupancy issues are detected, such as identifying when tender times exceed optimal thresholds or when available terminal counts do not align with traffic patterns.

In various embodiments presented herein, an aggregation model processes operational data across all hours to identify and rank the predominant root causes affecting a store's self-checkout performance. This higher-level analysis enables store managers to understand systemic issues through smart aggregation of operational hours, providing actionable insights about recurring problems such as suboptimal staffing patterns, cash management inefficiencies, or policy compliance gaps that consistently impact terminal utilization.

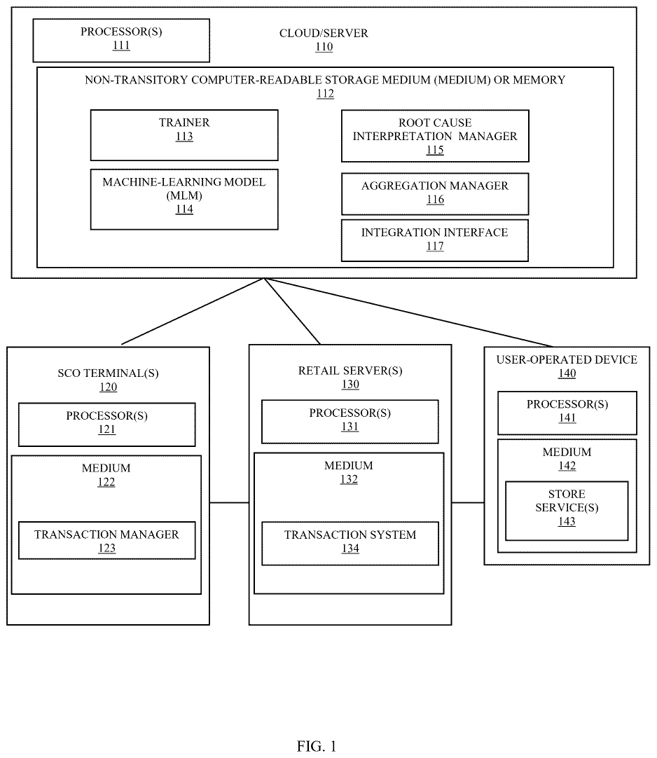

FIG. 1 is a diagram of a system 100 for SCO utilization optimization, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of SCO utilization optimization presented herein and below.

System 100 includes a cloud 110 or a server (hereinafter just “cloud 110” may also be referred to herein as “cloud server”), SCO terminals 120, one or more retail servers 130, and user-operated devices 140. Cloud 110 includes a processor 111 and a non-transitory computer-readable storage medium (medium) 112 and/or memory, which includes executable instructions for trainer 113, a MLM 114, a root cause interpretation manager 115, an aggregation manager 116, and an integration interface 117. Processor 111 executes the instructions causing processor 111 to perform operations discussed herein and below with respect to 113-117.

Each SCO terminal 120 includes a processor 121 and a non-transitory computer-readable storage medium 122 and/or memory, which includes instructions for a transaction manager 123. Processor 121 executes the instructions causing processor 121 to perform operations discussed herein and below with respect to transaction manager 123.

Each retailer server 130 includes a processor 131 and a non-transitory computer-readable storage medium 132 and/or memory, which includes executable instructions for a transaction system 134. Processor 131 executes the instructions causing processor 131 to perform operations discussed herein and below with respect to transaction system 134.

Each user-operated device 140 includes a processor 141 and a non-transitory computer-readable storage medium 142 and/or memory, which includes instructions for one or more store service 143. Processor 141 executes the instructions causing processor 141 to perform operations discussed herein and below with respect to store service 143.

In an embodiment, the trainer 113 processes millions of hourly operational data samples to train MLM 114, utilizing specific features including: average tender time measuring transaction payment duration, average clear time representing intervals between transactions, average itemization time for item entry duration, average intervention time for attendant assistance, transaction volume ratios comparing current transactions to store averages, and average available time representing terminal operational availability. The trainer 113 uses these operational parameters as input features and occupancy states as labels to train MLM 114 to establish relationships between operational parameters and their impact on terminal utilization.

In an embodiment, the MLM 114 is a Random Forest Classifier that analyzes the operational data to determine occupancy states including: adequate capacity indicating good balance between terminal count and traffic, capacity exceeding traffic suggesting too many open terminals, traffic exceeding capacity indicating insufficient open terminals, and insufficient lanes open regardless of traffic. The MLM 114 processes the operational parameters to identify root causes affecting these occupancy states, enabling data-driven optimization of terminal utilization.

In an embodiment, the root cause interpretation manager 115 implements SHAP (Shapley Additive Explanations) analysis to determine the effect of each operational parameter on the occupancy state. When analyzing parameters like tender time, clear time, or intervention time, the root cause interpretation manager 115 calculates specific threshold values that would transition the system from a suboptimal state to adequate capacity. These interpretations provide actionable insights about necessary parameter adjustments to achieve optimal utilization.

In an embodiment, the aggregation manager 116 processes operational data across all hours to identify and rank predominant root causes affecting a store's self-checkout performance. Through smart aggregation of operational hours, the aggregation manager 116 analyzes patterns in staffing, cash management efficiency, and policy compliance to identify systemic issues impacting terminal utilization. This higher-level analysis enables comprehensive understanding of recurring problems affecting SCO performance.

In an embodiment, the transaction manager 123 executes self-service transactions on SCO terminals 120, interacting with the transaction system 134 to process customer purchases. During these transactions, the transaction manager 123 and transaction system 134 capture operational metrics including tender times, clear times, itemization times, and intervention events. This transaction data, combined with historical SCO transaction data, provides the training dataset used by trainer 113 to continuously improve MLM 114's analytical capabilities.

In an embodiment, the integration interface 117 processes the analytical outputs from MLM 114, root cause interpretation manager 115, and aggregation manager 116 to generate specific recommendations for improving SCO utilization. These recommendations are transmitted to store services 143 on user-operated devices 140, where they are presented through dashboard interfaces that enable store managers to visualize relationships between operational parameters and occupancy states. The integration interface 117 provides specific guidance for each hour where occupancy issues are detected, such as identifying when tender times exceed optimal thresholds or when available terminal counts do not align with traffic patterns.

In an embodiment, the trainer 113 implements specialized data preprocessing algorithms to transform raw operational data into engineered features suitable for the MLM 114. For each hourly sample, the trainer processes transaction timestamps and durations to compute normalized values for tender time, clear time, itemization time, and intervention time, while also calculating relative transaction volumes by comparing against historical store averages and time-specific patterns. This feature engineering process ensures the MLM 114 can effectively learn from temporal patterns in the operational data.

In an embodiment, when processing transaction volume features, the trainer 113 computes two distinct ratios: the number of transactions divided by the average number of transactions for the store, and the number of transactions divided by the average number of transactions for that specific store and hour. The trainer 113 also calculates the average available time by aggregating the total seconds all SCO terminals 120 are operational during each hour. These carefully engineered features enable the MLM 114 to contextualize current operational states against both overall store patterns and time-specific historical performance.

In an embodiment, the trainer 113 implements a systematic validation process during feature engineering to ensure data quality and relevance. Through iterative analysis, the trainer 113 has identified and removed features that showed low impact on model performance, such as different terminal status indicators, basket characteristics, and other transaction attributes. This refinement process ensures the MLM 114 focuses on the most influential parameters affecting terminal utilization, improving both computational efficiency and prediction accuracy.

In an embodiment, the Random Forest Classifier MLM 114 processes the operational parameters through multiple decision trees that analyze different combinations of features to determine occupancy states. For each hour of operation, the MLM 114 evaluates specific feature combinations including: the ratio of actual transactions to average transactions for that store, the ratio of transactions to average transactions for that specific hour and store, and the cumulative available time across all terminals. These ratios and measurements enable the MLM 114 to contextualize current operational states against historical patterns.

In an embodiment, the MLM 114 implements parallel processing of decision trees to evaluate how combinations of operational parameters correlate with different occupancy states. When processing tender time and clear time parameters, each decision tree analyzes how variations in these times impact transaction throughput relative to terminal availability. The MLM 114 aggregates these individual tree analyses to generate robust predictions about occupancy states and their root causes. This parallel analysis structure enables the MLM 114 to handle the complexity of multiple interacting parameters while maintaining computational efficiency.

In an embodiment, during the occupancy state determination process, the Random Forest Classifier MLM 114 evaluates the operational parameters against learned thresholds that distinguish between adequate capacity, capacity exceeding traffic, traffic exceeding capacity, and insufficient lanes open states. The MLM 114 processes each parameter's contribution to the current state through multiple decision paths, enabling identification of both primary and secondary factors affecting terminal utilization. This multi-path analysis provides a comprehensive understanding of how different operational parameters interact to create specific occupancy states.

In an embodiment, the root cause interpretation manager 115 implements SHAP analysis by computing Shapley values that measure each feature's contribution to moving from the MLM's base prediction to the actual prediction for a specific occupancy state. When analyzing operational parameters, the SHAP analysis quantifies how each parameter value pushes the prediction away from the expected occupancy state, enabling precise identification of which parameters most strongly influence suboptimal states. The root cause interpretation manager 115 processes these Shapley values to determine the magnitude and direction of each parameter's effect on the occupancy state.

In an embodiment, to calculate optimal threshold values, the root cause interpretation manager 115 leverages the SHAP analysis results to identify specific parameter ranges associated with adequate capacity states. For tender time analysis, the system 100 evaluates historical operational data where SHAP values indicate a transition from traffic-exceeding-capacity to adequate capacity, computing potential threshold values that would achieve this transition. The root cause interpretation manager 115 validates these thresholds by analyzing their consistency across multiple time periods and stores with similar operational characteristics.

In an embodiment, the SHAP analysis process enables the root cause interpretation manager 115 to evaluate complex interactions between multiple operational parameters simultaneously. For example, when analyzing tender times in conjunction with intervention times, the system 100 can determine how different combinations of these parameters affect occupancy states and calculate optimal ranges for both parameters that together would achieve adequate capacity. This multi-parameter analysis provides more nuanced and actionable recommendations for optimizing terminal utilization.

In an embodiment, the aggregation manager 116 implements a multi-layered temporal analysis process to identify systemic issues affecting SCO utilization. At the first layer, the aggregation manager 116 processes hourly operational data through sliding time windows, analyzing how operational parameters cluster across different time periods to identify recurring patterns. This temporal clustering enables the system 100 to distinguish between isolated incidents and systemic issues that consistently impact terminal utilization.

In an embodiment, for each operational parameter, the aggregation manager 116 computes statistical distributions across different time scales—hourly, daily, and weekly—to establish baseline performance metrics. The system 100 then applies weighted scoring algorithms to evaluate deviations from these baselines, with greater weight assigned to recent time periods and high-traffic operational hours. This weighted analysis enables more precise identification of systemic issues while accounting for temporal variations in store operations.

In an embodiment, the aggregation manager 116 correlates identified root causes across multiple time periods using pattern recognition algorithms that detect recurring relationships between operational parameters and occupancy states. When processing staffing patterns, for example, the system 100 analyzes how variations in attendant-to-terminal ratios consistently correlate with specific occupancy states across different time periods. These correlation patterns enable the system 100 to rank root causes by their systemic impact on terminal utilization and generate prioritized recommendations for operational improvements.

In an embodiment, the integration interface 117 implements specialized data transformation algorithms to convert the analytical outputs from MLM 114, root cause interpretation manager 115, and aggregation manager 116 into actionable recommendations. For each occupancy state analysis, the interface processes raw parameter correlations through natural language interpretation mappings that translate technical findings into clear operational guidance. This transformation process enables the system 100 to communicate complex analytical results through intuitive visualizations and specific recommendations.

In an embodiment, when processing SHAP analysis results, the integration interface 117 applies parameter-specific interpretation frameworks to generate targeted recommendations. The interface evaluates the calculated potential values against operational constraints and historical performance patterns to ensure recommendations are both achievable and impactful. For example, when processing tender time recommendations, the system 100 considers factors such as transaction complexity and customer behavior patterns to generate realistic optimization targets.

In an embodiment, the integration interface 117 implements a dynamic dashboard generation system that creates customized visualizations based on the processed analytical outputs. The system 100 plots relationships between root cause values and occupancy states through interactive graphs that enable store managers to explore different parameter combinations and their predicted impacts on utilization. These visualizations are complemented by specific interpretations for each hour where occupancy issues are detected, providing clear guidance on which operational parameters require adjustment to achieve optimal utilization.

In an embodiment, the integration interface 117 implements a real-time dashboard updating system that refreshes operational visualizations as new data becomes available. When processing current operational metrics, the system dynamically adjusts recommendation priorities based on real-time conditions while maintaining context from historical patterns identified by the aggregation manager 116. This integration of real-time monitoring with historical analysis enables store managers to make informed operational adjustments that account for both immediate needs and systemic patterns.

In an embodiment, the system 100 implements real-time monitoring capabilities through continuous data collection and analysis between the transaction manager 123 and transaction system 134. During active store operations, these components capture and process operational metrics including tender times, clear times, intervention events, and transaction volumes, enabling immediate detection of emerging utilization issues. This real-time data collection integrates with the MLM's analytical processing to enable dynamic evaluation of current operational states against learned patterns.

In an embodiment, when processing real-time operational data, the root cause interpretation manager 115 continuously evaluates current parameter values against the optimal thresholds determined through SHAP analysis. If the system 100 detects parameters trending toward suboptimal ranges, it generates proactive alerts through the integration interface 117 to enable preventive adjustments before utilization issues fully manifest. This predictive capability helps maintain optimal SCO terminal utilization by enabling store managers to address potential issues before they impact customer experience.

In an embodiment, the cloud server 110 implements a distributed processing architecture that enables scalable analysis across multiple store locations while maintaining consistent model performance. The cloud-based deployment allows the trainer 113 to aggregate operational data from multiple stores, enriching the training dataset while preserving store-specific patterns through specialized feature engineering that accounts for individual location characteristics.

In an embodiment, when processing data from multiple locations, the MLM 114 maintains separate analytical contexts for each store while leveraging cross-store patterns to enhance prediction accuracy. This architecture enables the MLM 114 to identify both store-specific utilization patterns and broader operational trends that apply across multiple locations, providing insights that can be applied both locally and globally to improve terminal utilization.

In an embodiment, the root cause interpretation manager 115 and aggregation manager 116 implement parallel processing capabilities that enable simultaneous analysis of multiple store locations without degrading computational performance. When generating interpretations and recommendations, these components consider both store-specific operational constraints and cross-location performance benchmarks, enabling the system 100 to provide contextually appropriate optimization guidance while maintaining consistent analysis quality across the retail network.

In an embodiment, the integration interface 117 implements a multi-tenant architecture that enables secure, isolated access to store-specific dashboards while maintaining the ability to generate cross-location performance comparisons. This architectural design allows store managers to access detailed analytics for their specific location while enabling higher-level retail management to analyze patterns and optimize operations across multiple stores, demonstrating the system's capability to scale efficiently while maintaining analytical precision.

In an embodiment, the Random Forest MLM 114 implements specific technical improvements through its specialized processing of operational parameters. Unlike conventional machine learning approaches that process retail data as simple time series, this MLM 114 evaluates complex feature interactions through parallel decision trees that analyze how combinations of tender time, clear time, itemization time, intervention time, and transaction volumes correlate with different occupancy states. This multi-dimensional analysis enables more precise identification of root causes compared to traditional single-parameter analysis methods.

In an embodiment, the Random Forest MLM 114 incorporates store-specific operational contexts by computing normalized transaction ratios at multiple time scales—comparing current transactions against both overall store averages and time-specific historical patterns. This contextual processing enables the MLM 114 to identify utilization patterns that would be missed by conventional machine learning approaches that rely solely on absolute transaction counts or simple averages. The MLM's ability to maintain separate analytical contexts while leveraging cross-store patterns provides superior prediction accuracy compared to traditional retail analytics systems.

In an embodiment, when processing operational parameters, the MLM 114 implements an advanced feature validation system that has identified and eliminated low-impact parameters through iterative analysis. This refinement process distinguishes the MLM 114 from generic machine learning implementations by focusing computational resources on the most influential parameters affecting terminal utilization. The MLM's ability to dynamically adjust feature weights based on their demonstrated impact on occupancy states enables more efficient and accurate analysis compared to static machine learning approaches.

In an embodiment, the MLM 114 evaluates the operational parameters to generate specific recommendations for different occupancy states. For capacity exceeding traffic states, the MLM 114 recommends closing a portion of the SCO terminals 120. For traffic exceeding capacity and insufficient lanes open states, the MLM 114 generates targeted recommendations addressing high tender times, clear times, itemization times, intervention times, or low available time based on the specific parameters identified as root causes.

In an embodiment, the MLM 114 maintains separate analytical contexts for different times of day at each store location. This temporal contextualization enables the MLM 114 to evaluate whether the current number of transactions is high relative to that specific hour at that specific store, providing more precise occupancy state determinations. The MLM 114 uses this temporal context to ensure recommendations account for typical traffic patterns and operational characteristics of each time period.

In an embodiment, the MLM 114 implements continuous learning capabilities that enable it to refine its analytical precision as it processes additional operational data across multiple store locations. Unlike conventional machine learning approaches that use static training datasets, the trainer 113 continuously incorporates new transaction data from the transaction manager 123 and transaction system 134 to enhance the MLM's feature engineering and prediction capabilities. This dynamic training process enables the MLM 114 to automatically adapt and fine-tune itself as sales patterns change over time.

In an embodiment, the MLM 114 leverages cross-location learning to identify broader operational patterns while maintaining store-specific analytical contexts. As the trainer 113 processes operational data from additional store locations, it enriches the MLM's understanding of how different combinations of operational parameters impact occupancy states across diverse retail environments. This multi-location learning enables the MLM 114 to distinguish between location-specific patterns and universal trends, providing increasingly refined recommendations as it processes more operational data.

In an embodiment, the trainer 113 implements an adaptive feature validation process that continuously evaluates the predictive value of different operational parameters as new data becomes available. This ongoing validation enables the MLM 114 to dynamically adjust feature weights and eliminate low-impact parameters, ensuring the MLM 114 maintains optimal computational efficiency while improving prediction accuracy over time. The system's ability to automatically learn from experience and adapt to changing sales patterns ensures it remains relevant and effective as retail operations evolve.

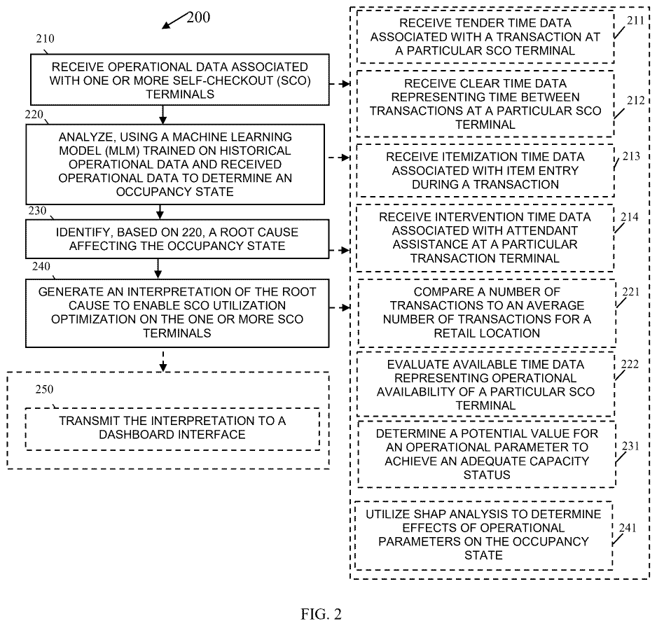

FIG. 2 illustrates a flow diagram of a method 200 for SCO utilization optimization, according to an example embodiment. The software module(s) that implements the method 200 is referred to as a “SCO utilization optimizer.” The SCO utilization optimizer is implemented as executable instructions programmed and residing within memory and/or a non-transitory computer-readable (processor-readable) storage medium and executed by one or more processors of one or more devices. The processor(s) of the device(s) that executes the SCO utilization optimizer are specifically configured and programmed to process the SCO utilization optimizer. The SCO utilization optimizer has access to one or more network connections during its processing. The connections can be wired, wireless, or a combination of wired and wireless.

In an embodiment, the device that executes SCO utilization optimizer is cloud 110. In an embodiment, the device that executes SCO utilization optimizer is retail server 130. In an embodiment, the SCO utilization optimizer is all of, or some combination of 113-117. In an embodiment, the SCO layout optimizer is provided to a retail server 130 and/or a user-operated device 140 as a software-as-a-service (SaaS).

At 210, the SCO utilization optimizer receives operational data associated with one or more SCO terminals 120. In an embodiment, at 211, the SCO utilization optimizer receives tender time data associated with a transaction at a particular SCO terminal 120. In an embodiment, at 212, the SCO utilization optimizer receives clear time data representing time between transactions at a particular SCO terminal 120.

In an embodiment, at 213, the SCO utilization optimizer receives itemization data associate with item entry during a transaction at a particular SCO terminal 120. In an embodiment, at 214, the SCO utilization optimizer receives intervention time data associated with attendant assistance at a particular SCO terminal 120.

At 220, the SCO utilization optimizer analyzes, using a MLM 114 trained on historical operational data and received operational data to determine an occupancy state. In an embodiment, at 221, the MLM 114 compares a number of transaction to an average number of transactions for a retail location. In an embodiment, at 222, the MLM 114 evaluates available time data representing operational availability of a particular SCO terminal 120.

At 230, the SCO utilization optimizer identified, based on 220, a root cause affecting the occupancy state of the one or more SCO terminals 120. In an embodiment, at 231, the SCO utilization optimizer determines a potential value for an operational parameter to achieve an adequate capacity status at the one or more SCO terminals 120.

At 240, the SCO utilization optimizer generates an interpretation of the root cause to enable SCO utilization optimization on the one or more SCO terminals 120. In an embodiment, at 241, the SCO utilization optimizer utilizes a SHAP analysis to determined effects of operational parameters on the occupancy state. In an embodiment, at 250, the SCO utilization optimizer transmits the interpretation to a dashboard interface or a store service 143.

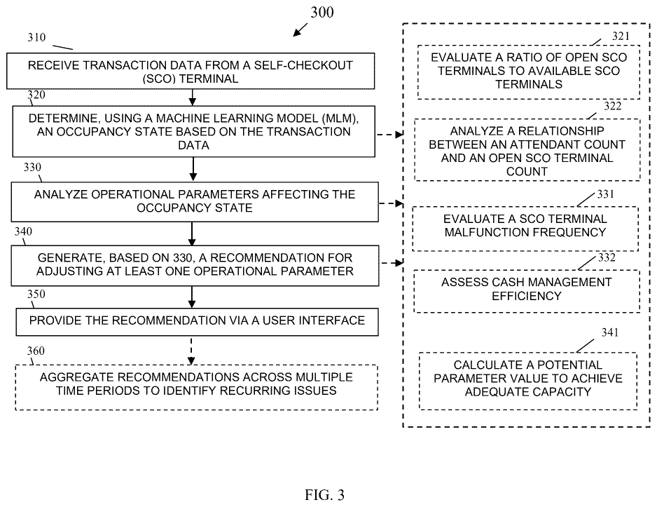

FIG. 3 illustrates a flow diagram of another method 300 for SCO utilization optimization, according to an example embodiment. The software module(s) that implements the method 300 is referred to as a “SCO utilization optimization manager.” The SCO utilization optimization manager is implemented as executable instructions programmed and residing within memory and/or a non-transitory computer-readable (processor-readable) storage medium and executed by one or more processors of one or more devices. The processor(s) of the device(s) that executes the SCO utilization optimization manager are specifically configured and programmed to process the SCO utilization optimization manager. The SCO utilization optimization manager has access to one or more network connections during its processing. The network connections can be wired, wireless, or a combination of wired and wireless.

In an embodiment, the device that executes the SCO utilization optimization manager is cloud 110. In an embodiment, the device that executes the SCO utilization optimization manager is retail server 130. In an embodiment, the SCO utilization optimization manager is provided to a retail server 130 and/or a user-operated device 140 as a SaaS.

In an embodiment, the SCO utilization optimization manager is all of, or some combination of 113-117, and/or method 200. The SCO utilization optimization manager presents another and, in some ways, enhanced processing perspective from that which was discussed above with the method 200 of the FIG. 2.

At 310, the SCO utilization optimization manager receives transaction data from a SCO terminal 120. At 320, the SCO utilization optimization manager determines, using MLM 114, an occupancy state for the SCO terminal 120 based on the transaction data.

In an embodiment, at 321, the MLM 114 evaluates a ration of open SCO terminals 120 to available SCO terminals 120. In an embodiment, at 322, the MLM 114 analyzes a relationship between an attendant count and an open SCO terminal count.

At 330, the SCO utilization optimization manager analyzes operational parameters affecting the occupancy state. In an embodiment, at 331, the SCO utilization optimization manager evaluates a SCO terminal malfunction frequency. In an embodiment, at 332, the SCO utilization optimization manager accesses cash management efficiency at the SCO terminal 120.

At 340, the SCO utilization optimization manager generates, based on 330, a recommendation for adjusting at least one operational parameter. In an embodiment, at 341, the SCO utilization optimization manager calculates a potential parameter value to achieve an adequate capacity at the SCO terminal 120.

At 350, the SCO utilization optimization manager provides the recommendation through a user interface such as integration interface 117. In an embodiment, at 360, the SCO utilization optimization manager aggregates recommendations across multiple time periods to identify recurring issues.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving operational data associated with one or more self-checkout (SCO) terminals;
analyzing, using a machine learning model (MLM) trained on historical operational data and received operational data to determine an occupancy state;
identifying, based on the analyzing, a root cause affecting the occupancy state; and
generating an interpretation of the root cause to enable SCO utilization optimization on the one or more SCO terminals.

2. The method of claim 1, wherein receiving the operational data comprises receiving tender time data associated with a transaction at a particular SCO terminal.

3. The method of claim 1, wherein receiving the operational data comprises receiving clear time data representing time between transactions at a particular SCO terminal.

4. The method of claim 1, wherein receiving the operational data comprises receiving itemization time data associated with item entry during a transaction.

5. The method of claim 1, wherein receiving the operational data comprises receiving intervention time data associated with attendant assistance at a particular SCO terminal.

6. The method of claim 1, wherein analyzing the operational data comprises comparing a number of transactions to an average number of transactions for a retail location.

7. The method of claim 1, wherein analyzing the operational data comprises evaluating available time data representing operational availability of a particular SCO terminal.

8. The method of claim 1, wherein analyzing the operational data comprises using a trained random forest classifier as the MLM.

9. The method of claim 1, wherein identifying the root cause comprises determining a potential value for an operational parameter to achieve an adequate capacity status.

10. The method of claim 1, wherein generating the interpretation comprises utilizing Shapely Additive Explanations (SHAP) analysis to determine effects of operational parameters on the occupancy state.

11. The method of claim 1, further comprising transmitting the interpretation to a dashboard interface.

12. A method, comprising:
receiving transaction data from a self-checkout (SCO) terminal;
determining, using a machine learning model (MLM), an occupancy state based on the transaction data;
analyzing operational parameters affecting the occupancy state;
generating, based on the analyzing, a recommendation for adjusting at least one operational parameter; and
providing the recommendation via a user interface.

13. The method of claim 12, wherein determining the occupancy state comprises evaluating a ratio of open SCO terminals to available SCO terminals.

14. The method of claim 12, wherein determining the occupancy state comprises analyzing a relationship between an attendant count and an open SCO terminal count.

15. The method of claim 12, wherein analyzing the operational parameters comprises evaluating a SCO terminal malfunction frequency.

16. The method of claim 12, wherein analyzing the operational parameters comprises assessing cash management efficiency.

17. The method of claim 12, wherein generating the recommendation comprises calculating a potential parameter value to achieve adequate capacity.

18. The method of claim 12, further comprising aggregating recommendations across multiple time periods to identify recurring issues.

19. A system, comprising:
at least one processor; and
memory storing instructions that, when executed by the at least one processor, cause operations comprising:
receiving operational data from one or more self-checkout (SCO) terminals;
analyzing, using a machine learning model (MLM), the operational data to determine occupancy states of the one or more SCO terminals;
identifying root causes affecting the occupancy states; and
generating at least one interpretation enabling optimization of the one or more SCO terminals.

20. The system of claim 19, wherein the MLM comprises a random forest classifier trained on historical operational SCO data.
